(19) United States
(12) Patent Application Publication
(10) Pub. No.: US 2021/0253248 A1
(43) Pub. Date: Aug. 19, 2021

(54) AIRCRAFT WINGS WITH REDUCED WINGSPAN

(71) Applicant: Samir Hanna Safar, San Diego, CA (US)

(72) Inventor: Samir Hanna Safar, San Diego, CA (US)

(21) Appl. No.: 17/169,364

(22) Filed: Feb. 5, 2021

Related U.S. Application Data
(60) Provisional application No. 62/971,937, filed on Feb. 8, 2020.

(51) Int. Cl. B64C 39/08; B64C 3/38; B64D 27/18; B64C 3/32

(52) U.S. Cl. CPC B64C 39/08; B64C 3/38; B64C 5/06; B64C 3/32; B64D 27/18

(57) ABSTRACT

An aircraft wing device having one or more numbered wing sets, each wing set further comprising: one or more internal wings, one or more external wings and a transition unit. The internal wings are used to structurally connect the wing set with the main aircraft body, and the external wings are capable of being positionally adjusted and maneuvered by way of vertical, horizontal, or angular movement. The device not only reduces the wingspan of the traditionally used aircraft wings, but also provides better stability and reduces the takeoff time. The wing sets may be positionally staggered on the aircraft body, height wise for aerodynamics efficiency and lift efficiency.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the field of aircrafts having multiple wings. More specifically, the present invention relates to aircrafts with multiple wings, having a reduced wingspan, and being positionally adjustable, for better control of aerodynamics flow around the wings.

### BACKGROUND OF THE INVENTION

Several modifications for aircraft wings have been attempted for better aerodynamic flow around the wings of aircrafts. The research areas being focused include wide wingspan as well as better stability in the air.

Despite various improvements and progress in the field, some of the major obstacles still exist. The existing devices are unable to overcome the limitations of providing increased stability in the air and shorter wingspan which can help in accommodating more aircrafts in an airport.

Accordingly, improvements are needed in the existing devices that negate the above shortcomings. It is observed that the purpose and methodology of all the above inventions that are part of prior art do not envisage the unique embodiment of aircraft wings with reduced wingspan, as described in the present application. The scope of the invention is to be determined by the terminology of the following description, drawings, and the legal equivalents thereof.

### SUMMARY OF THE INVENTION

The present invention may be summarized, at least in part, with reference to its objects. The invention described herein thus comprises an aircraft wing device comprising a plurality of even numbered wing sets, each wing set further comprising: (a) a singularity or plurality of internal wings, (b) a singularity or plurality of external wings, (c) a transition unit, said transition unit having the singularity or plurality of internal wings structurally integrated on a first side of the transition unit and the singularity or plurality of external wings structurally integrated on a second side of the transition unit, wherein the singularity or plurality of internal wings are used to structurally connect the wing set with the main aircraft body, and the singularity or plurality of external wings are positionally adjustable and capable of being maneuvered by way of vertical, horizontal or angular movement.

It is therefore a primary objective of the present invention to provide an aircraft wing device which increases the stability of the aircraft when it is airborne.

Another objective of the present invention is to provide an aircraft wing device that helps in faster take off time of the aircraft.

Another objective of the present invention is to provide an aircraft wing device such that there is more precise control of aerodynamics flow around the wings.

Yet another objective of the present invention is to provide an aircraft wing device that reduces tremendously each wingspan out to the same length as the bucktail wings of an airplane.

A further objective of the present invention is to provide an aircraft wing device that eliminates the need for the long wings that extend so far out on each side, thus reducing the space required to park a commercial passenger aircraft in an airport.

Still another objective of the present invention is to provide an aircraft wing device that enables the aircraft to fly more efficiently in higher altitude.

The above summary is intended to illustrate exemplary embodiments of the invention, which will be best understood in conjunction with the detailed description to follow and are not intended to limit the scope of the invention. Additional objects and embodiments of the invention will be set forth in part in the description which follows, and in part will become apparent to those skilled in the art upon examination of the following or may be learned by practice of the invention. Thus, these and other objects of the present invention will be more readily apparent when considered in reference to the following description and when taken in conjunction with the accompanying drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a side perspective view illustrating the component parts of the wing assembly for an aircraft equipped with wings having a reduced wingspan as taught by the present invention.

FIG. 2 is a top perspective view illustrating the component parts of the wing assembly for an aircraft equipped with wings having a reduced wingspan as taught by the present invention where multiple reduced wingspan wing assemblies are utilized.

FIG. 3 is a side perspective view illustrating the component parts of the wing assembly for an aircraft equipped with wings having a reduced wingspan as taught by the present invention where a single reduced wingspan wing assembly is utilized on the top and bottom of the fuselage.

FIG. 4 is a side perspective view illustrating the component parts of the wing assembly for an aircraft equipped with wings having a reduced wingspan as taught by the present invention where multiple reduced wingspan wing assemblies are utilized on the top and bottom of the fuselage.

FIG. 5 is a top perspective view illustrating the component parts of the wing assembly for an aircraft equipped with wings having a reduced wingspan as taught by the present invention where multiple reduced wingspan wing assemblies are utilized on the left and right sides of the fuselage.

FIG. 6 is a side perspective view illustrating the component parts of the wing assembly for an aircraft equipped with wings having a reduced wingspan as taught by the present invention where a single reduced wingspan wing assembly is utilized on the top and bottom of the fuselage.

FIG. 7 is a side perspective view illustrating the component parts of the wing assembly for an aircraft equipped with wings having a reduced wingspan as taught by the present invention where multiple reduced wingspan wing assemblies are utilized on the left and right sides of the fuselage.

FIG. 8 is a side perspective view illustrating the component parts of the wing assembly for an aircraft equipped with wings having a reduced wingspan as taught by the present invention where a single reduced wingspan wing assembly is utilized on the top and bottom of the fuselage.

FIG. 9 is a front perspective view illustrating the component parts of the wing assembly for an aircraft equipped with wings having a reduced wingspan as taught by the present invention where a single reduced wingspan wing assembly is utilized on the top and bottom of the fuselage.

FIG. 10 is a front perspective view illustrating the component parts of the wing assembly for an aircraft equipped with wings having a reduced wingspan as taught by the present invention where multiple reduced wingspan wing assemblies are utilized on the left and right sides of the fuselage.

FIG. 11 is a side perspective view illustrating the component parts of the wing set assembly as taught by the present invention.

FIG. 12 is a front perspective view illustrating the component parts of the wing set assembly as taught by the present invention.

FIG. 13 is an expanded illustration showing the component parts of one embodiment of the present invention as applied to a BOEING 737.

FIG. 14 illustrates the present invention as applied to a BOEING 737.

FIG. 15 illustrates the case results for an embodiment of the invention with the front wings up and back wings down with three varying wing angles of attack (AoA).

FIG. 16 is a graph illustrating the force for various AoAs for an embodiment of the invention with the front wings up and back wings down.

FIG. 17 illustrates the case results for an embodiment of the invention with the front wings and back wings extended with three varying wing angles of attack.

FIG. 18 is a graph illustrating the force for various AoAs for an embodiment of the invention with the front wings and back wings extended.

FIG. 19 illustrates the case results for an embodiment of the invention with the front and back wings down with three varying wing angles of attack.

FIG. 20 is a graph illustrating the force for various AoAs for an embodiment of the invention with the front and back wings down.

FIGS. 21-23 illustrate an embodiment of the invention with the front and back wings in an extended position.

### LIST OF REFERENCE CHARACTERS

1 denotes an aircraft body,
2 denotes a right-hand side (RHS) outer front wings,
3 denotes a RHS outer back wings,
4 denotes a left-hand side (LHS) outer front wings
5 denotes a LHS outer back wings
6 denotes a LHS transition unit
7 denotes a RHS transition unit
8 denotes a transition cap
9 denotes a LHS outer front small wings
10 denotes a RHS outer back small wings
11 denotes a transition cap
12 denotes a LHS outer back small wings
13 denotes a RHS outer front small wings
14 denotes an aircraft,
20 denotes a wing set,
21 denotes internal wings,
22 denotes a transition unit,
23 denotes external wings.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention is an aircraft wing device comprising a plurality of even numbered wing sets 20, each wing set 20 further comprising: (a) a singularity or plurality of internal wings 21, (b) a singularity or plurality of external wings 23, and (c) a transition unit 22, said transition unit 22 having the singularity or plurality of internal wings 21 structurally integrated on a first side of the transition unit 22 and the singularity or plurality of external wings 23 structurally integrated on a second side of the transition unit 22, wherein the singularity or plurality of internal wings 21 are used to structurally connect the wing set with the main aircraft 14 body or fuselage, and the singularity or plurality of external wings 23 are positionally adjustable and capable of being maneuvered by way of vertical, horizontal, or angular movement.

FIG. 11 is a side perspective view illustrating the component parts of the wing set 20 assembly as taught by the present invention. Here, the wing set 20 is comprised of a transition unit 22 with one or more internal wings 21 extending radially from the transition unit 22 and one or more external wings 23 extending radially from the transition unit 22.

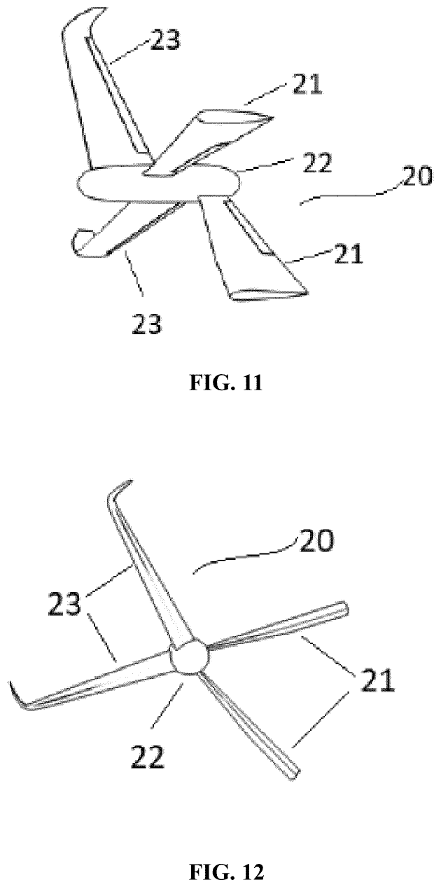

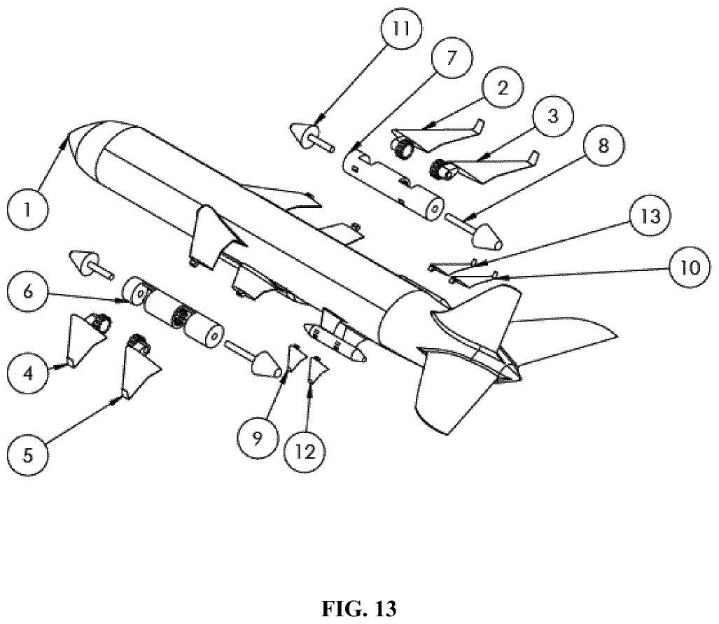

FIG. 12 is a front perspective view illustrating the component parts of the wing set 20 assembly as taught by the present invention. Again, the wing set 20 is comprised of a transition unit 22 with one or more internal wings 21 extending radially from the transition unit 22 and one or more external wings 23 extending radially from the transition unit 22.

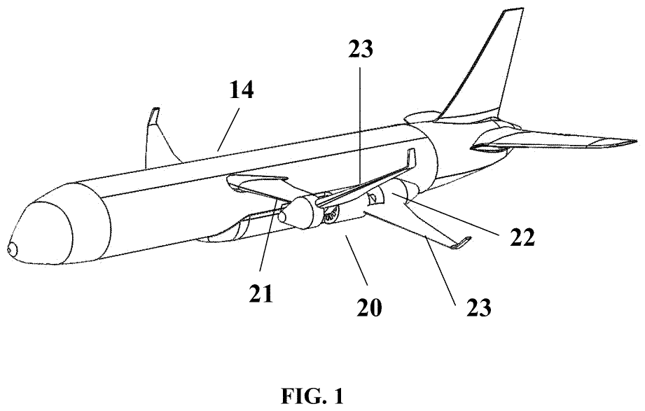

Now referring to FIG. 1, a side perspective view illustrating the component parts of the wing sets 20 for an aircraft equipped with wings having a reduced wingspan as taught by the present invention is illustrated. Here the wing set 20 is attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22 and keeping or retaining the rear vertical and horizontal tails/stabilizers.

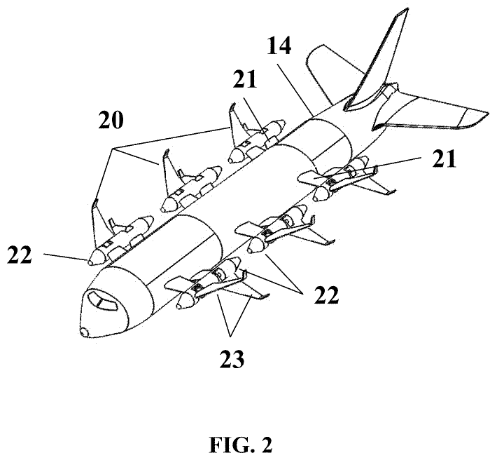

FIG. 2 is a top perspective view illustrating the component parts of the wing sets 20 for an aircraft equipped with wings having a reduced wingspan as taught by the present invention where multiple reduced wingspan wing set 20 assemblies are utilized. Here a plurality of wing sets 20 are attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22. In the embodiment illustrated in FIG. 2, three wing sets 20 are attached to the left and right sides of the plane's 14 fuselage replacing the standard wing and keeping or retaining the rear vertical and horizontal tails/stabilizers.

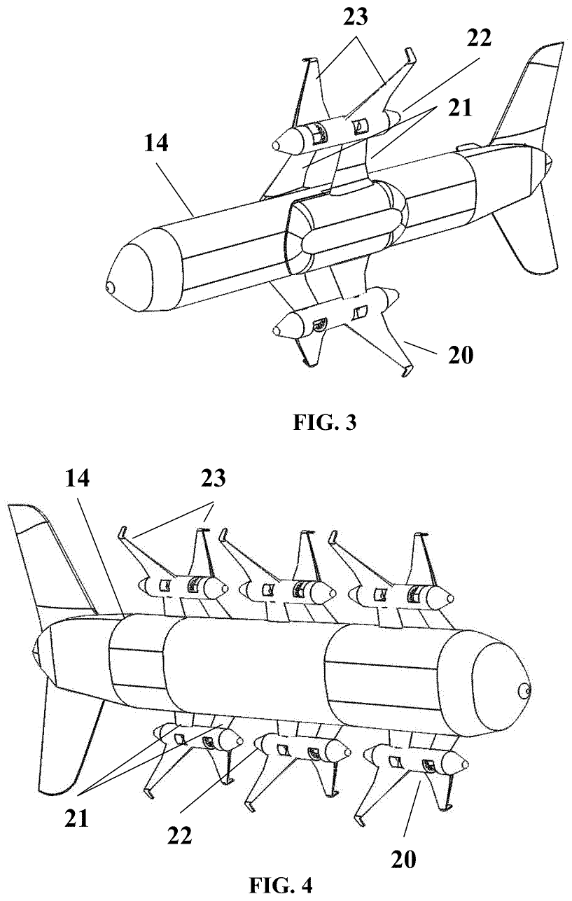

FIG. 3 is a side perspective view illustrating the component parts of the wing assembly 20 for an aircraft equipped with wings having a reduced wingspan as taught by the present invention where a single reduced wingspan wing set 20 assembly 20 is utilized on the top and bottom of the plane's 14 fuselage. Here the wing set 20 is attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22 and keeping or retaining the rear vertical tails/stabilizers.

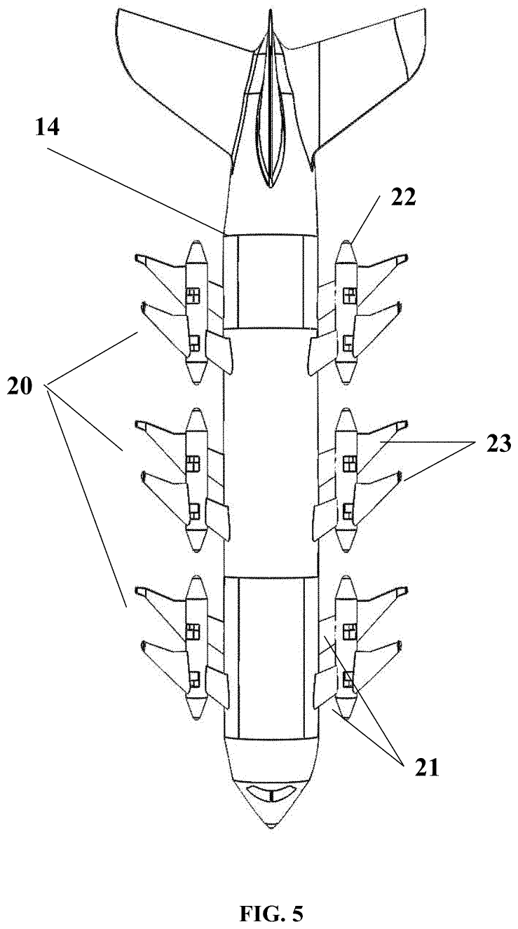

FIG. 4 is a side perspective view illustrating the component parts of the wing set 20 assembly for an aircraft equipped with wings having a reduced wingspan as taught by the present invention where multiple reduced wingspan wing set 20 assemblies are utilized on the top and bottom of the plane's 14 fuselage. Here a plurality of wing sets 20 are attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22. In the embodiment illustrated in FIG. 2, three wing sets 20 are attached to the left and right sides of the plane's 14 fuselage replacing the standard wing and keeping or retaining the rear vertical and horizontal tails/stabilizers.

FIG. 5 is a top perspective view illustrating the component parts of the wing set 20 assembly for an aircraft equipped with wings having a reduced wingspan as taught by the present invention where multiple reduced wingspan wing set 20 assemblies are utilized on the left and right sides of the plane's 14 fuselage. Here a plurality of wing sets 20 are attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22. In the embodiment illustrated in FIG. 2, three wing sets 20 are attached to the left and right sides of the plane's 14 fuselage replacing the standard wing and keeping or retaining the rear vertical and horizontal tails/stabilizers.

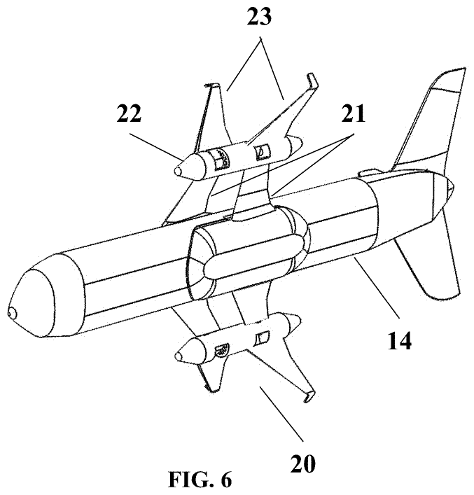

FIG. 6 is a side perspective view illustrating the component parts of the wing set 20 assembly for an aircraft equipped with wings having a reduced wingspan as taught by the present invention where a single reduced wingspan wing set 20 assembly is utilized on the top and bottom of the plane's 14 fuselage. Here the wing set 20 is attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22 and keeping or retaining the rear vertical and horizontal tails/stabilizers.

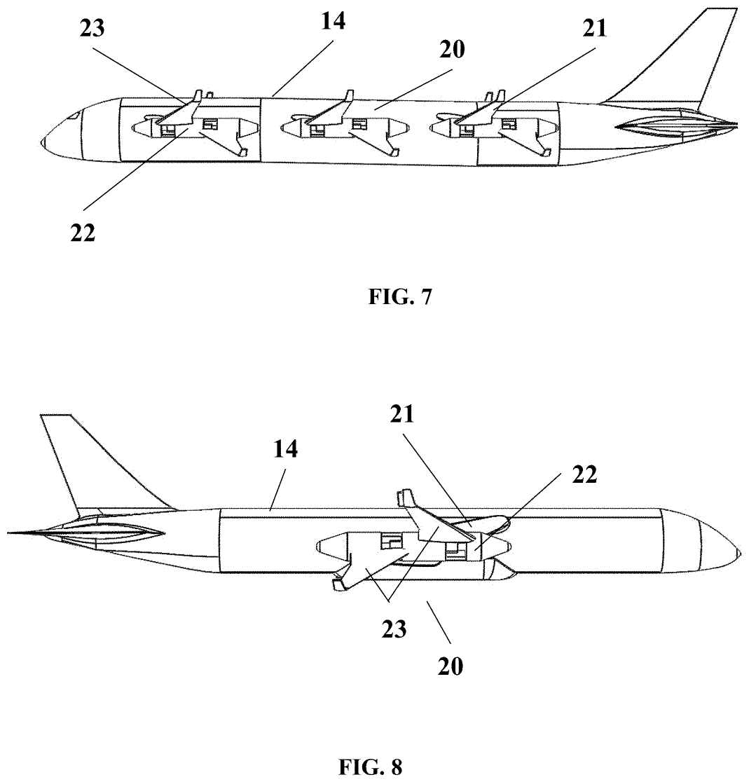

FIG. 7 is a side perspective view illustrating the component parts of the wing set 20 assembly for an aircraft equipped with wings having a reduced wingspan as taught by the present invention where multiple reduced wingspan wing set 20 assemblies are utilized on the left and right sides of the plane's 14 fuselage. Here a plurality of wing sets 20 are attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22. In the embodiment illustrated in FIG. 2, three wing sets 20 are attached to the left and right sides of the plane's 14 fuselage replacing the standard wing and keeping or retaining the rear vertical and horizontal tails/stabilizers.

FIG. 8 is a side perspective view illustrating the component parts of the wing assembly for an aircraft equipped with wings having a reduced wingspan as taught by the present invention where a single reduced wingspan wing assembly is utilized on the top and bottom of the plane's 14 fuselage. Here the wing set 20 is attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22 and keeping or retaining the rear vertical and horizontal tails/stabilizers.

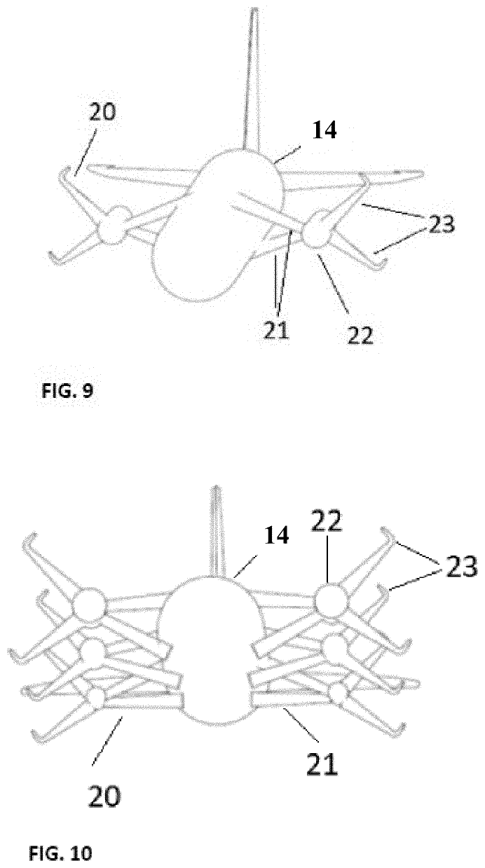

FIG. 9 is a front perspective view illustrating the component parts of the wing set 20 assembly for an aircraft equipped with wings having a reduced wingspan as taught by the present invention where a single reduced wingspan wing set 20 assembly is utilized on the top and bottom of the plane's 14 fuselage. Here the wing set 20 is attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22 and keeping or retaining the rear vertical and horizontal tails/stabilizers.

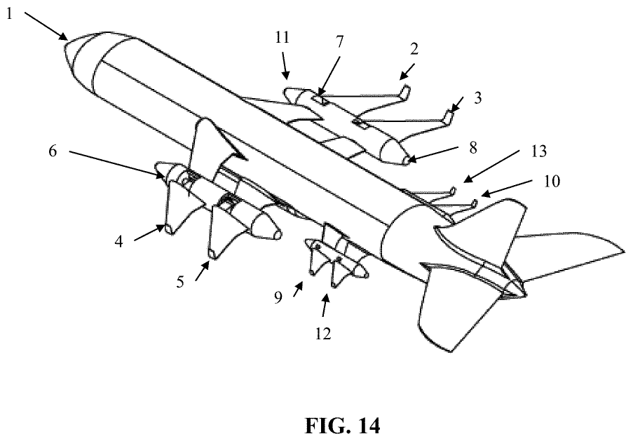

FIG. 14 is a front perspective view illustrating the component parts of the wing set 20 assembly for an aircraft equipped with wings having a reduced wingspan as taught by the present invention where multiple reduced wingspan wing set 20 assemblies are utilized on the left and right sides of the plane's 14 fuselage. Here a plurality of wing sets 20 are attached to the side of a standard airplane 14 fuselage replacing the standard wing. The wing set 20 is comprised of a transition unit 22 with one or more internal wings 21 extending radially from the transition unit 22 and one or more external wings 23 extending radially from the transition unit 22. In the embodiment illustrated in FIG. 2, three wing sets 20 are attached to the left and right sides of the plane's 14 fuselage replacing the standard wing and keeping or retaining the rear vertical and horizontal tails/stabilizers.

Through rigorous testing with resulting being non-obvious to those of ordinary skill in the art are and through a series of design evaluations and evolutions and refinements, the embodiments illustrated and discussed previously were found to have the most potential application and market success for providing an aircraft with a reduced wing design that was not only functional, but also provided an acceptable balance between stability and maneuverability in the air and on the ground.

The inventors process started with a plurality of potential design, none of which had a known or obvious outcome. Next a simulation and testing phase was conducted as part of the research and development process. Using complex computational fluid design (CFD) software, an analysis was done of the various potential designs. This resulted in many refinements and changes throughout the research and development process as the general in aviation and wing design is a tradeoff between maneuverability and stability where lesser maneuverability results in higher stability and higher stability results in less maneuverability both on the air, and as a side effect on the ground when an aircraft is in taxi.

During the research and development phase many results were mixed and unexpected. The main goal of the research and the present invention was to reduce the span of wings, which was successfully done but not always with the desired result or tradeoff with respect to maneuverability and stability during flight.

As a result of the proposed wing designs, the Inventor(s) had to deal with solving a dihedral effect and other specific phenomenons that became visible during CFD analysis and features of the design that were shown advantageous and others that were disadvantageous. The Dihedral effect is the aerodynamic effect for stability of aircraft due to the angle between wings with horizontal axis, which then caused the Inventor(s) to focus in on various combinations and issues with the multiple wing set 20 designs ranging from side and wing orientations and orientation combinations. As a result of research and development results such as the various CFD simulations and interpretations, the Inventor(s) was forced to create better design ideas and better optimized designs to improve on the initial, general design concept and the engineer problems and issues associated with the initial, general design concept, which were not-obvious, not a matter of design choice, and were not a result of repetitive or incremental research and development practices.

The engineering problem was designing, selecting, and then simulating a plurality of wing design configurations of aircraft to see if they could producing lift and how they behave under some conditions. For the multiple wind set 20 embodiment of the present invention, as shown specifically in FIGS. 13-15 as discussed above, but applicable to all embodiments, it was decided to choose three angle of attacks (AoAs or AoA): (1) Front wings up and Back wing down, (2) Extended wings, and (3) Front wings down and back wing down with set typical cruising speed at a typical flying elevation feet.

Complex CFD was completed using leading software simulations such as ANSYS, OPENFOAM, FLUENT, and K-Omega turbulence modeling that provided results not only related to fluid flows but other structural and thermal analysis. Additionally, turbulence modeling was also conducted, which is notoriously difficult to model and obtain valid results and among the many models currently available for use, none have been so well establish to be generally or universally accepted and each available model has different strengths and weaknesses based on project goals and geometries being examined.

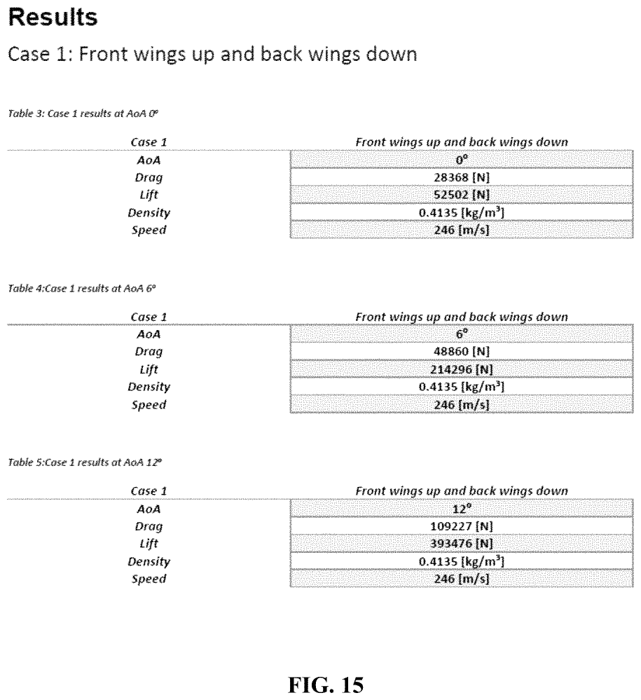

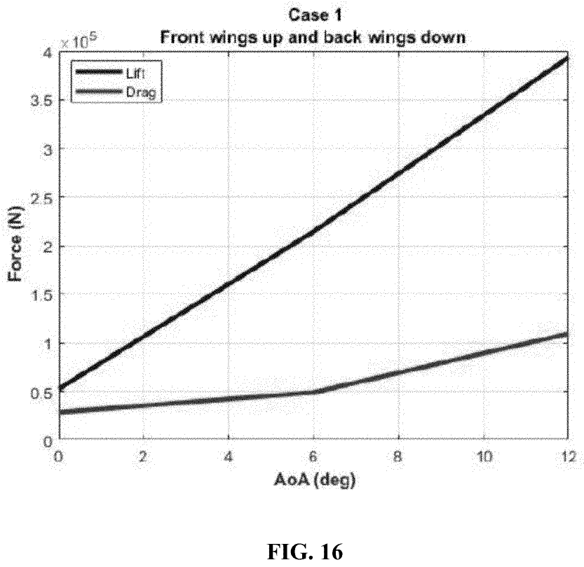

FIGS. 15-16 illustrate the CFD analysis results for an embodiment with the front wings up and the back wing down in a double wind set embodiment. The wing span in this configuration is 14.6 m. When isolating the flow visualization around the wing only, the inner back wings were seen to be in direct influence of the wake of inner front wings. Meanwhile, the smaller fixed wings at the back does not seem to have much effect. The function of winglets there was found to be not completely efficient due to turbulent vortices coming from the transition. The wing tip vortices of the front wings had disturbed the smooth flow over the surface of back wings.

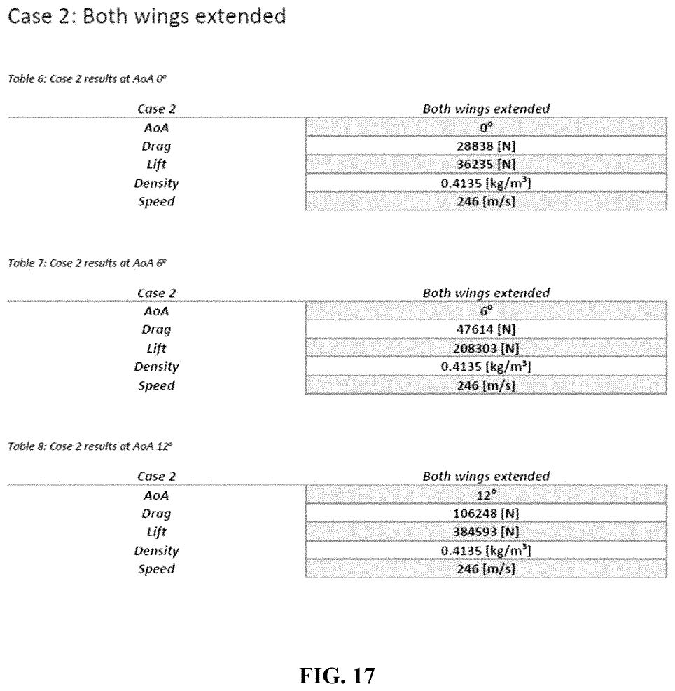

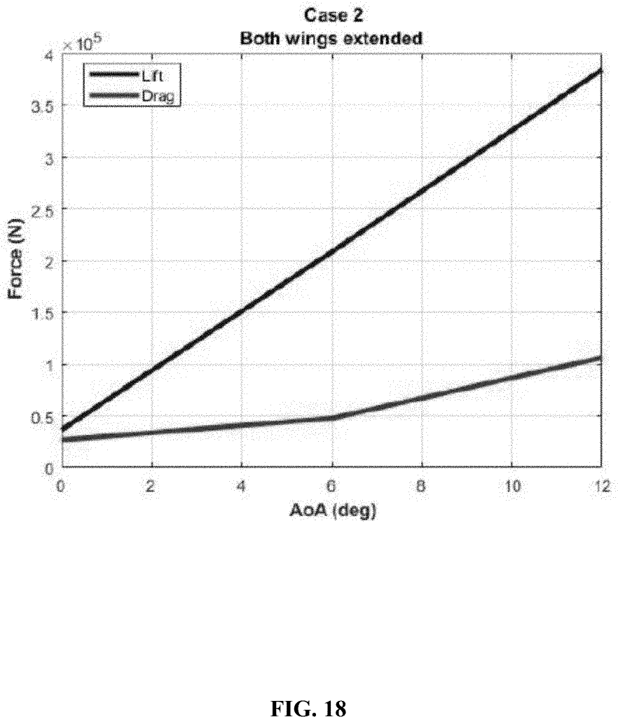

FIGS. 17-18 illustrate the CFD analysis results for an embodiment with the front wing and back wings extended in a double wind set embodiment. This configuration has the span of 15.9 m. It was found that the flow of the streamlines in the inner side of the transition wedge is similar to other configurations. In the outer side though, the root side of the outward back wing has received a disturbed flow that is not capable of generating high lift. Since the drag is similar to the that of the both wing upward position, the only factor differing these two is the lift coefficient. The lift coefficient of this configuration is higher by 0.004 value which makes it more effective than the both upward. Also, there is a lesser wake on the horizontal stabilizer than the both upward position from stream lines analysis.

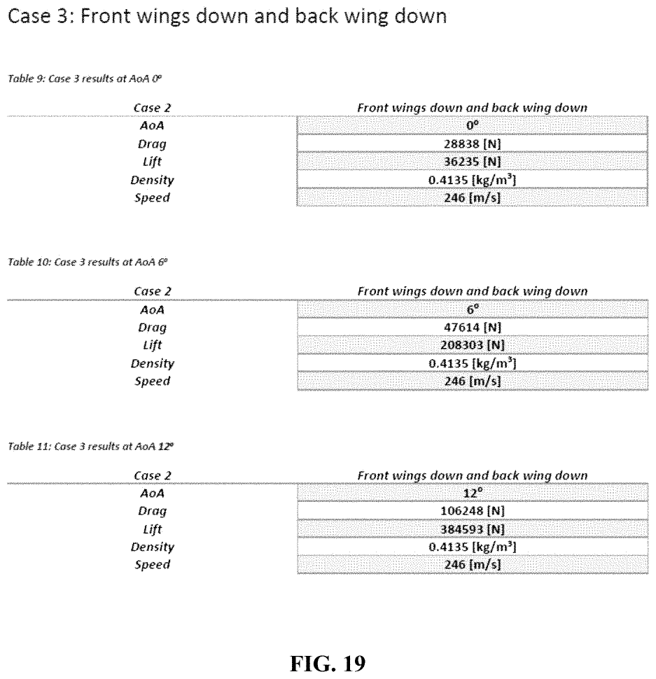

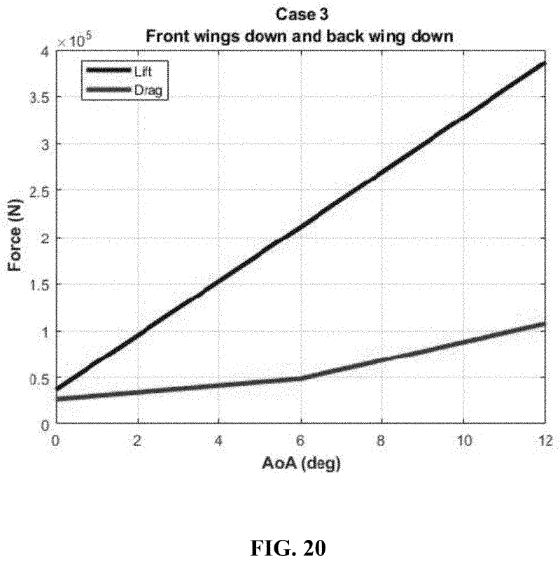

FIGS. 19-20 illustrate the CFD analysis results for an embodiment with the front wings and the back wings down in a double wind set embodiment. This wing configuration has span of 15.5 m. It was discovered that smaller fixed wings at the back received the same type of flow pattern as in the other configurations. On the movable outer wings though, it was found that a higher generation of lift than in the fully extended configuration is generated.

Through extensive research and development, the both wing down and both wing up configuration can be compared closely with the fully extended wing configuration because the flow patterns are similar except for the fact that the point of center of pressure is different in these three configurations and the effective dihedral angle is changing.

The minimum requirement for steady and balance flight is the lift to balance the weight of an aircraft. The conditions for leveled flight were studies as part of the extensive research and development. It was observed that the coefficient of lift for all the configurations proposed were higher than the baseline lift coefficient. This implies the capability of aircraft to maintain level flight with minimum sizing correction in inner wings that can produce equal aerodynamic lift force as the Maximum Take Off Weight of the aircraft. Additionally, the total lift force was within the same range which indicates the availability of sufficient lift for a level flight. Hence, the wings designs proposed herein are capable of generating enough lift for the aircraft.

The span of the default wing is 30.5 m and the span of new configuration ranges from 14.6 m for the both up configuration to 15.9 m for both extended position. This reduces the span by maximum of 52.13%. Results from existing aerodynamic studies conclude that the wingspan extension gradually reduces the longitudinal and directional static stability of the aircraft; however, it aids more in lateral stability at higher angles of attack. This allows the aircraft to maneuver swiftly in necessary flight conditions as well as maintain proper stability in crosswind landing at high angle of attack. Changing the effective dihedral of the wing by morphing the outer wing can influence the stability of aircraft greatly. Past researches in sweep morphing (for dihedral) has proven that it remarkably increases roll subsidence.

Complete Vehicle design process requires the assessment of aerodynamic, structures, propulsion and flight dynamics. The aerodynamic analysis of the Boeing 737 with new conceptual design was done as part of the Inventor's development. Because, flight dynamics deals with the response of aerospace vehicles to perturbations in their flight environments and to control inputs. Since it is changes in orientation (or attitude) that are most important, these responses are dominated by the generated aerodynamic and propulsive moments. Based on the moments developed by the morphing wing proposed, horizontal stabilizer and elevator sizing can be designed to balance the static and dynamic stability of the aircraft.

In alternate embodiments, the transition units 21 embody a jet engine depending on the design and the size of the airplane.

In alternate embodiments, an aircraft can have only one wing set 20 instead of a plurality of even numbered wing sets 20.

In different embodiments, the number of internal wings 21 in a wing set 20 may be one or more.

Similarly, in different embodiments, the number of external wings 23 in a wing set 20 may be one or more.

In preferred embodiments, the external wings 23 are provided with curved tips at the end. The curve may be in upward or downward direction. The curve is typically at a 90-degree angle with respect to the extended surface of the wing, but any angle can be used that reduces drag and creates additional efficiency.

In accordance with the present invention, there are four main embodiments of a wing set as follows: (1) a single internal wing 21, a transition unit 22 and a single external wing 23, (2) a single internal wing 21, a transition unit 22 and a pair of external wings 23, (3) a pair of internal wings 21, a transition unit 22 and a single external wing 23, (4) a pair of internal wings 21, a transition unit 22 and a pair of external wings 23.

In alternate embodiments, more than one transition unit 22 may be provided.

The external wings 23 are capable of movement in upward and downward (vertical) direction, left and right (horizontal) direction, as well as tilting or twisting (angular movement). The movement of the external wings 23 can be controlled by the pilot or artificial intelligence-based software.

In different embodiments, the multiple wing sets on each side of the aircraft are not provided at the same level. The wing sets may be positionally staggered on the aircraft body, height wise for aerodynamics efficiency and lift efficiency. This is depicted in FIG. 7.

In alternate embodiments, the plurality of internal wings 21 may be more than two.

In alternate embodiments, the plurality of external wings 23 may be more than two.

Various configurations and arrangements of the internal and external wings 23 in a wing set provide specific functional benefits. According to the type of aerodynamic flow and design of the aircraft (or vehicle), specific wing set can be used. The number of wing sets used in an aircraft can also vary.

Now referring to FIGS. 13 and 14, an exemplary embodiment of the present invention as applied to a BOEING 737 is illustrated. FIG. 13 provides an expanded parts view of the present invention where a BOEING 737 aircraft body 1 has right hand side (RHS) outer front wings 2 and RHS outer back wings 3 attached on one side with left hand side (LHS) outer front wings 4 and LHS outer back wings 5 attached on an opposing side of the body 1. A LHS transition unit 6 and RHS transition unit 7 provide a central attachment location for the right-hand side (RHS) outer front wings 2 and RHS outer back wings 3 and left-hand side (LHS) outer front wings 4 and LHS outer back wings 5. Transition caps 8 and 11 are provided on the forward or front facing side of the transition units 6 and 7 to reduce drag. Additional LHS outer front small wings 9 and LHS outer back small wings 11 are included as well as matching RHS outer back small wings 10 and RHS outer front small wings 12 on the opposite side of the body 10.

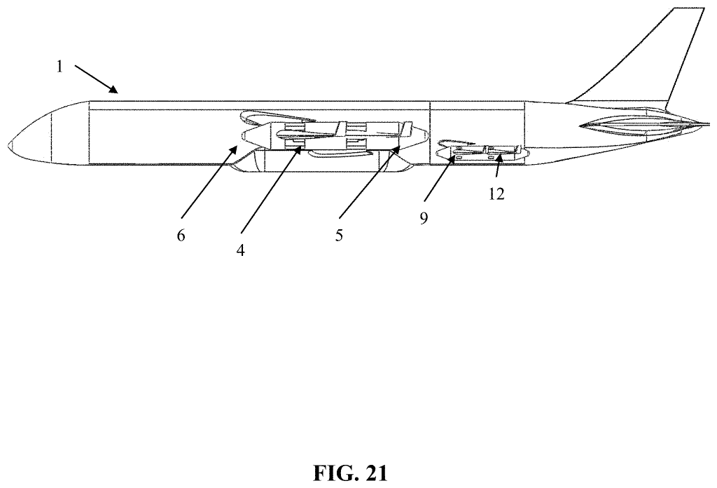

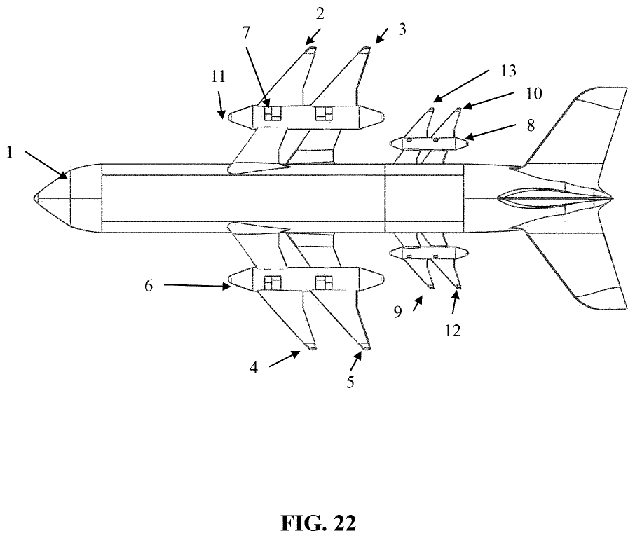

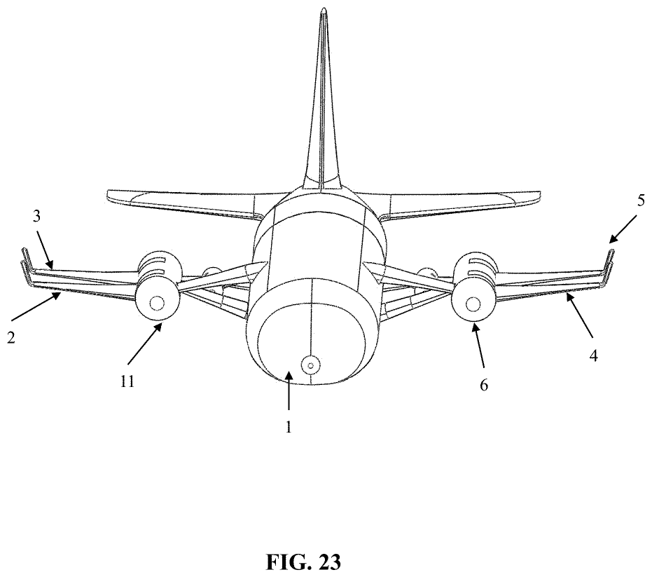

Now referring to FIGS. 21-23 an embodiment of the invention with the front and back wings in an extended position is also illustrated. In this embodiment, as compared to other embodiments, the component parts of the invention are the same, although various wind directions and configuration combinations can be utilized and not all wing combinations and configurations tested and possible are illustrated as such permutations would be readily obvious to a person of ordinary skill in the art and not all variations require illustration for understanding.

In FIGS. 21-23, the aircraft body 1 has right hand side (RHS) outer front wings 2 and RHS outer back wings 3 attached on one side with left hand side (LHS) outer front wings 4 and LHS outer back wings 5 attached on an opposing side of the body 1. A LHS transition unit 6 and RHS transition unit 7 provide a central attachment location for the right-hand side (RHS) outer front wings 2 and RHS outer back wings 3 and left-hand side (LHS) outer front wings 4 and LHS outer back wings 5. Transition caps 8 and 11 are provided on the forward or front facing side of the transition units 6 and 7 to reduce drag. Additional LHS outer front small wings 9 and LHS outer back small wings 11 are included as well as matching RHS outer back small wings 10 and RHS outer front small wings 12 on the opposite side of the body 10.

In this exemplary embodiment, a BOEING 737 is retrofitted with two wing sets 20 on each side of the body 10. A larger first set or pair closer to the nose or front of the body 10, and a second small set or pair closer to the rear or tail of the body 10, each consisting of the basic parts of the invention, that being one or more internal wings 21 extending from a transition unit 22 with one or more external wings 23.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An aircraft wing device set configured to be attached to the fuselage of an airplane, the aircraft wing device set comprising,
one or more internal wings;
one or more external wings; and
a transition unit;
the transition unit has one or more internal wings structurally integrated on a first side of the transition unit; and
one or more external wings structurally integrated on a second side of the transition unit, and wherein
the one or more internal wings are used to structurally connect the wing set with the main aircraft body or fuselage.

2. The device of claim 1, wherein
the one or more external wings are positionally adjustable and capable of being maneuvered by way of vertical, horizontal, or angular movement.

3. The device of claim 2, wherein
the movement of the external wings is configured to be controlled by a pilot or an artificial intelligence-based software.

4. The device of claim 1, wherein the device is comprised of
a single internal wing,
a transition unit, and
a single external wing.

5. The device of claim 1, wherein the device is comprised of
a single internal wing,
a transition unit, and
a plurality of external wings.

6. The device of claim 1, wherein the device is comprised of
a pair of internal wings,
a transition unit, and
a single external wing.

7. The device of claim 1, wherein the device is comprised of
a pair of internal wings,
a transition unit, and
a pair external wings.

8. The device of claim 1, wherein the device is comprised of
one or more internal wings,
a transition unit, and
a pair of external wings.

9. The device of claim 1, wherein the device is comprised of
a pair of internal wings,
a transition unit, and
one or more external wings.

10. The device of claim 1, wherein
the external wings are provided with curved tips at the end.

11. The device of claim 11, wherein
the curved end is in an upward or downward direction with respect to the extended stop surface of the wing.

12. The device of claim 1, wherein
a single wing set is attached to the left and right side of a standard airplane fuselage;
the wing set is comprised of
the transition unit with
one or more internal wings extending radially from the transition unit; and
one or more external wings extending radially from the transition unit.

13. The device of claim 1, wherein
a plurality of wing sets are attached to the left and right sides of a standard airplane fuselage;
each wing set is comprised of
the transition unit with
one or more internal wings extending radially from the transition unit; and
one or more external wings extending radially from the transition unit.

14. The device of claim 13, wherein
the multiple wing sets on each side of the aircraft are not provided at the same level; and
the wing sets may be positionally staggered on the aircraft body, height wise for aerodynamics efficiency and lift efficiency.

15. The device of claim 14, wherein
three wing sets are attached to the left side and right side of the plane's fuselage replacing the standard wing and keeping or retaining the rear vertical and horizontal tails/stabilizers.

16. The device of claim 1, wherein
a single wing set is attached to a top side and a bottom side of a standard airplane fuselage;
the wing set is comprised of
the transition unit with
one or more internal wings extending radially from the transition unit; and
one or more external wings extending radially from the transition unit.

17. The device of claim 1, wherein
a plurality of wing sets are attached to the top side and bottom side of a standard airplane fuselage;
each wing set is comprised of
the transition unit with
one or more internal wings extending radially from the transition unit; and
one or more external wings extending radially from the transition unit.

18. The device of claim 17, wherein
the multiple wing sets on each side of the aircraft are not provided at the same level; and
the wing sets may be positionally staggered on the aircraft body, height wise for aerodynamics efficiency and lift efficiency.

19. The device of claim 17, wherein
three wing sets are attached to the left side and right side of the plane's fuselage replacing the standard wing and keeping or retaining the rear vertical and horizontal tails/stabilizers.

20. The device of claim 1, comprising
a plurality of even numbered wing sets.

21. The device of claim 1, wherein
the transition units embody a jet engine.

22. The device of claim 1, further comprising
more than one transition unit provided per wing set.
